(19) United States
(12) Patent Application Publication
(10) Pub. No.: US 2009/0136276 A1
(43) Pub. Date: May 28, 2009

(54) IMAGE-FORMING APPARATUS

(75) Inventors: Takefumi TAMURA, Tokyo (JP); Yuuichi TAKAHASHI, Yoshikawa-shi (JP); Daisuke NAKAMURA, Nagareyama-shi (JP); Daisuke SASAKI, Kashiwa-shi (JP)

Correspondence Address: PATENTTM.US, P. O. BOX 82788, PORTLAND, OR, 97282-0788, US

(73) Assignee: CANON FINETECH INC., Ibaraki (JP)

(21) Appl. No.: 12/270,801

(22) Filed: Nov. 13, 2008

(30) Foreign Application Priority Data
Nov. 22, 2007 (JP) 2007-302741

(51) Int. Cl. G03G 15/00

(52) U.S. Cl. 399/397

(57) ABSTRACT

An image-forming apparatus is provided which is capable of forming an image on an intended position on a recording medium regardless of the paper sheet width (whether the sheet is wide or narrow). The image-forming apparatus 10 has a first recording head 31 which moves only within a first one side (right side in FIG. 1) of a first delivery belt 21 in the paper sheet width direction (arrow-B direction and arrow-C direction) perpendicular to the arrow-A direction. In the downstream side of the first delivery belt 21 in the arrow-A direction and slightly rightward in the paper sheet width direction, a second delivery belt 22 of an endless type extending in the arrow-A direction is provided for delivering the recording medium in the arrow-A direction. A second recording head 32 is provided which moves in the paper sheet width direction only within a second one side of the second delivery belt 22 opposite to the first one side.

### TECHNICAL FIELD

The present invention relates to an image-forming apparatus for forming an image on a predetermined fixed position on a recording medium delivered by pressing the surface of the recording medium.

### BACKGROUND TECHNIQUE

The ink-jet type of image-forming apparatuses which form an image by ejecting ink from a recording head onto a recording medium include two types. One is a serial type which forms an image by scanning with a recording head in a scanning direction (recording medium width direction) perpendicular to the recording medium delivery direction. The other is a fixed head type (a line printer) which has plural recording heads longer than the recording medium width and is placed fixedly in the recording medium delivery direction for ejecting an ink.

The serial type of image-forming apparatus requires a scanning mechanism for scanning with a recording head at a high speed with high precision. On the other hand, the fixed head type of image forming apparatus, although the scanning mechanism is not necessary, requires a long recording head. This involves problems of technical difficulty and high production cost. Usually both types of the recording heads are capable of forming an image over the entire area of the recording medium.

However, on some recording mediums, an image is required to be formed on a limited small region on the surface. For example, on a recording medium like a label, a bar-code is printed on a predetermined small region (fixed position) on the recording medium; on a recording medium like a postcard or an envelope, a stamp or other information is printed on the predetermined position. Such a single-purpose image-forming apparatus for forming an image only at a predetermined limited position can be constituted of a simple apparatus without requiring the above-mentioned scanning mechanism of the serial type or a long recording heads of the fixed-head type. Such a type of known image-forming apparatus comprises a recording head which moves in the scanning direction (recording medium width direction) perpendicular to the recording medium delivery direction to the predetermined position and ejects ink thereon; a delivery belt for delivering the recording medium while pressing the recording medium; and a supporter for supporting the pressed recording medium at the reverse side. Hereinafter, this apparatus is called a position-fixed image-forming apparatus. (See, for example, Japanese Patent Application Laid-Open No. 2001-071585.)

In the aforementioned image-forming apparatus, in order to deliver the recording medium by pressing the surface of the recording medium with a delivery belt, the delivery belt and a belt-driving mechanism are placed on the recording medium face. Therefore, the recording head cannot be moved into the region (space) of the recording medium face on which the delivery belt and the driving mechanism are placed. In other words, the delivery belt and the driving mechanism are placed outside the range of movement of the recording head. When the position-fixed image-forming apparatus is relatively large in size for forming an image on a wide recording medium, this image-forming apparatus cannot form an image on a narrow recording medium sheet since the narrow recording medium comes to be placed between the delivery belts and cannot be delivered by the outside delivery belts. On the contrary, when the position-fixed image-forming apparatus is small in size for forming an image on a narrow recording medium, this image-forming apparatus cannot form an image on a predetermined position on a wide recording medium sheet since the delivery belt comes to be placed at the middle portion of the wide recording medium to narrow the image-forming region (printing region), making impossible the printing on a desired position on the recording medium.

### DISCLOSURE OF THE INVENTION

The present invention intends to provide an image-forming apparatus which is capable of forming an image on a desired position regardless of the paper sheet width (whether the sheet is wide or narrow).

For achieving the above objects, the image-forming apparatus of the present invention for forming an image on a predetermined position of a recording medium by delivering the recording medium by pressing a face of the recording medium, the apparatus comprising:

(1) a first delivery means for delivering the recording medium by pressing a part of the face of the recording medium,
(2) a first recording head movable only within a first one side of the first delivery means in the width direction of the recording medium perpendicular to the delivery direction,
(3) a second delivery means placed in the downstream side of the first delivery means in the first one side in the width direction of the recording medium and delivers the recording medium by pressing a part of the face of the recording medium, and
(4) a second recording head movable within a second one side of the second delivery means opposite to the first one side.
(5) The first delivery means and the second delivery means may be respectively an endless type of delivery belt which delivers the recording medium by pressing the face of the recoding medium.
(6) A pair of guiding means extending in the width direction of the recording medium may be provided for guiding the first recording head and the second recording head in the paper sheet width direction.
(7) The pair of the guiding means may be constituted of cylindrical shafts.
(8) A spacer means may be provided for regulating the gap between the first recording head and the recording medium and between the second recording head and the recording medium.

### BRIEF DESCRIPTION OF THE DRAWINGS

FIG. 1 is an oblique perspective view taken from upside of an image-forming apparatus of the present invention. Members and parts not related to the present invention are omitted from the drawing.

FIG. 2 is an oblique perspective view taken from downside of an image-forming apparatus illustrated in FIG. 1. Members and parts not related to the present invention are omitted from the drawing.

FIG. 3 is a schematic bottom view taken from downside of the main portion of the image-forming apparatus illustrated in FIG. 1.

FIG. 4 is a schematic side view of one of delivery belts and periphery thereof.

FIG. 5 is a plan view of a printed bar-code.

FIG. 6 is a plan view of an envelope on which a letter stamp, an address, and a name are printed.

### BEST MODE FOR CARRYING OUT THE INVENTION

The image-forming apparatus of the present invention is capable of forming an image on a fixed position (a predetermined limited position) on a recording medium.

### Example 1

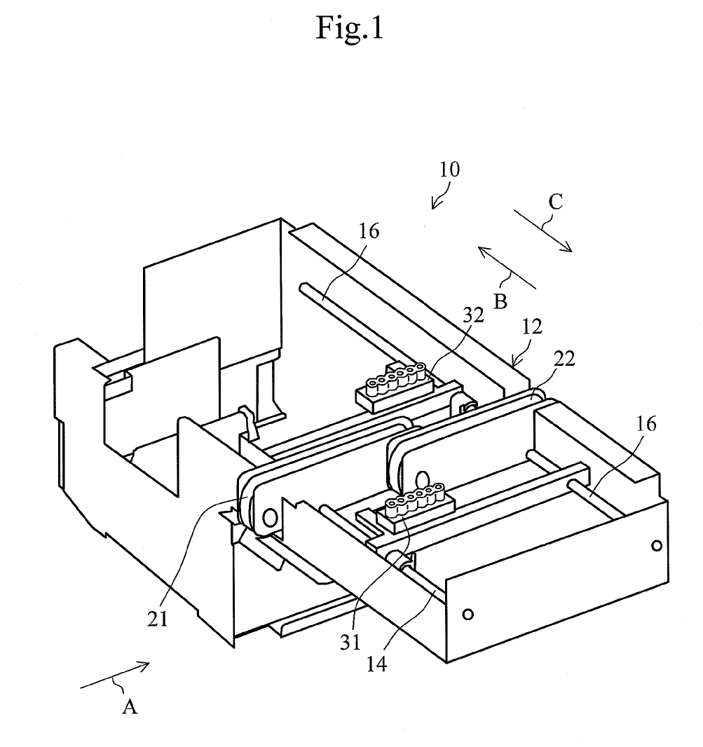

An example of the image-forming apparatus of the present invention is described with reference to FIGS. 1-4.

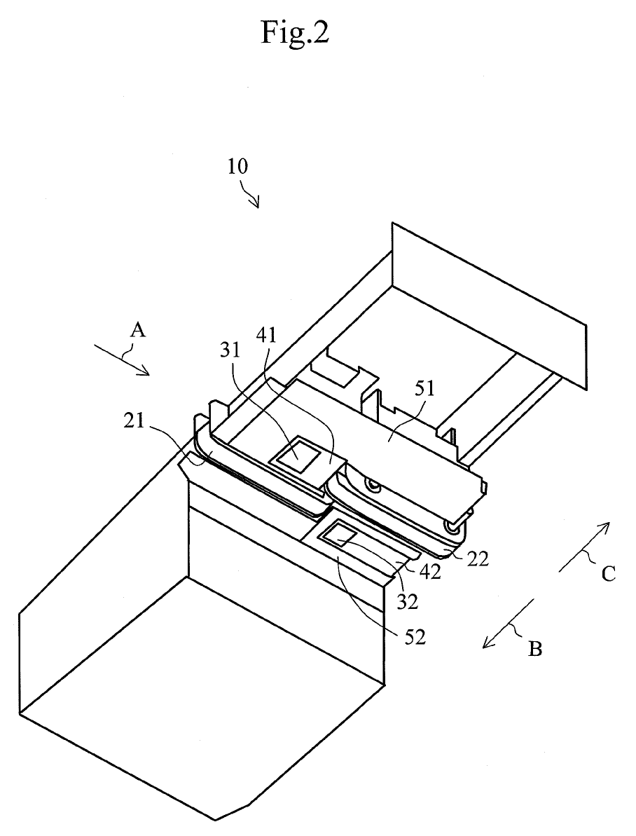

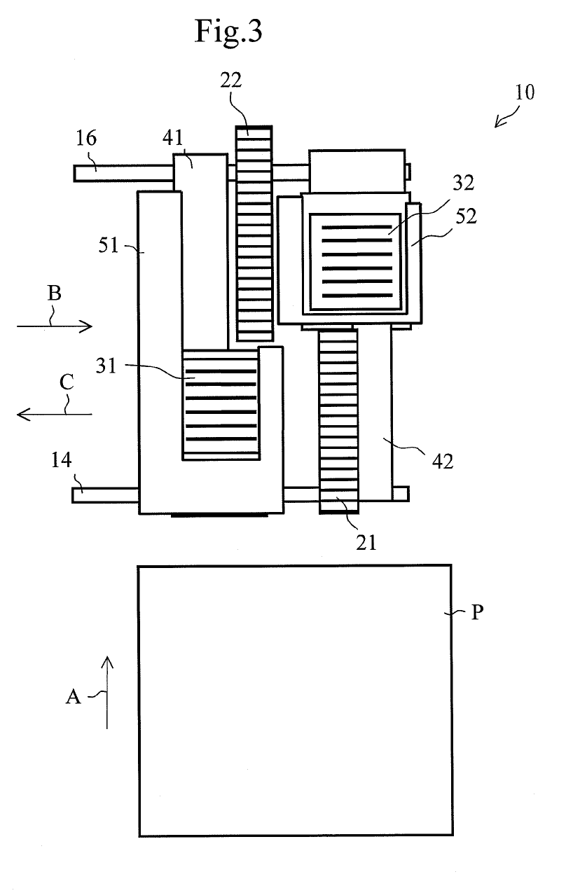

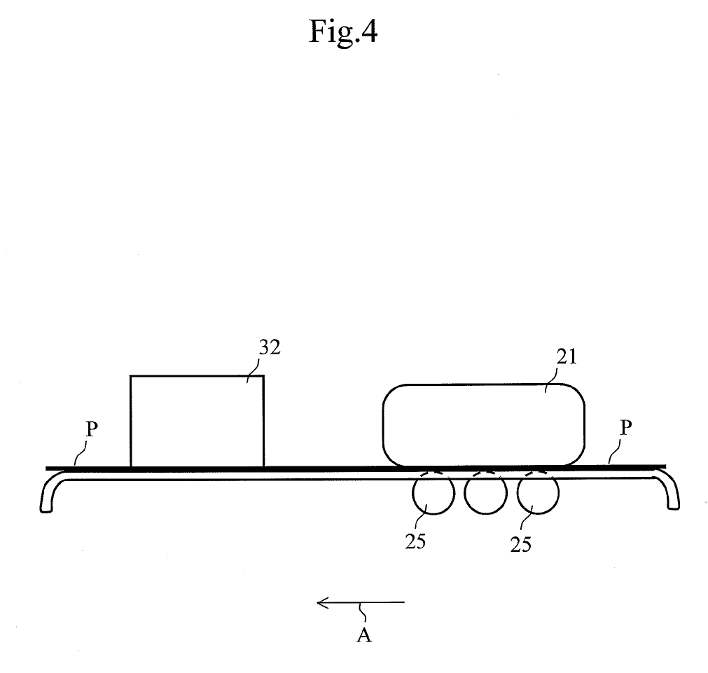

FIG. 1 is an oblique perspective view taken from upside of an image-forming apparatus of the present invention. Members and parts not related to the present invention are omitted from the drawing. FIG. 2 is an oblique perspective view taken from downside of an image-forming apparatus illustrated in FIG. 1. Members and parts not related to the present invention are omitted from the drawing. FIG. 3 is a schematic bottom view taken from downside of the main portion of the image-forming apparatus illustrated in FIG. 1. FIG. 4 is a schematic side view of one of delivery belts and periphery thereof.

The image-forming apparatus 10 is capable of forming an image on a predetermined position on a recording medium delivered in a predetermined delivery direction (arrow-A direction) by pressing the surface of a recording medium P (image formation surface). The image-forming apparatus 10 has various parts and members housed in a casing 12. The image-forming apparatus 10 has a first delivery belt 21 of an endless type (an example of the first delivery means of the present invention) extending in the arrow-A direction for delivering a recording medium P in the arrow-A direction. This first delivery belt 21 delivers the recording medium P in the arrow-A direction by pressing a part of the face of the recording medium P. During the delivery, as illustrate in FIG. 4, the recording medium P is held between the first delivery belt 21 and rollers 25 (three rollers in this Example) placed under the belt. The length of contact of the first delivery belt 21 with the surface of the recording medium P may be longer or shorter than the length of the recording medium P (the length in the arrow-A direction).

The image-forming apparatus 10 has a first recording head 31. This first recording head is movable in one side (a first one side) only of the first delivery belt 21 (right side viewed from upside in FIG. 1) in the paper sheet width direction (arrow-B direction and arrow-C direction) perpendicular to the arrow-A direction (paper sheet delivery direction). The first delivery belt 21 is placed on the face of the recording medium P. Therefore the first recording head 31 is not movable leftward beyond the first delivery belt 21 (to a second one side opposite to the above-mentioned first one side). The first recording head 31 is mounted on a first carriage 41, and moves in the arrow-B direction or the arrow-C direction and stops at any intended position. The first carriage 41 is held movably by a pair of guide shafts 14,16 extending in the arrow-B direction (or arrow-C direction), and moves along the shafts in the directions of arrow-B and arrow C.

On the downstream side of the first delivery belt 21 in the arrow-A direction and slightly rightward in the paper sheet width direction in FIG. 1, a second delivery belt 22 of an endless type (an example of the second delivery means in the present invention) is placed. This second delivery belt 22 delivers the recording medium P in the arrow-A direction by pressing a part of the face of the recording medium P. The length of contact of the second delivery belt 22 with the face of the recording medium P may be longer or shorter than the length of the recording medium P (the length in the arrow-A direction). The first delivery belt 21 and the second delivery belt 22 have the same constitution and the same size. A portion of the downstream side in the arrow-A direction of the first delivery belt 21 and a portion of the upstream side in the arrow-A direction of the second delivery belt 22 overlap slightly in the paper sheet width direction. Thereby the recording medium P which has been delivered from the upstream side in the arrow-A direction by the first delivery belt 21 is successively delivered by the second delivery belt 22.

The image-forming apparatus 10 has further a second recording head 32. This second recording head is movable in the other one side (a second one side, the left side in FIG. 1 viewed from upside) of the second delivery belt 22 (the other side of the above first one side, left side in FIG. 1) in the paper sheet width direction. This second delivery belt 22 is placed on the face of the recording medium P. Therefore the second recording head 32 is not movable rightward beyond the second delivery belt 22 (to the above-mentioned first one side). The second recording head 32 is mounted on a second carriage 42, and moves in the arrow-B direction or the arrow-C direction and stops at any intended position. The second carriage 42 is held movably by a pair of guide shafts 14,16 on which the first carriage 41 is held movably, and moves along the shafts in the directions of the arrow-B or the arrow-C. Otherwise, the shafts may be provided separately for holding the second carriage 42.

The image-forming apparatus 10 further has spacer plates 51,52 to keep constant the gap between the recording head 31 or 32 and the recording medium P. The spacer plates 51,52 presses the back side of the recording medium P to keep the gap constant between the recording heads 31, 32 and the recording medium P, even if the recording medium P swells or is curved. The two spacer plates 51,52 are roughly in a shape of a letter “U” respectively. The ink ejection nozzle outlets of the recording heads 31,32 are placed inside the U-shaped spacer plate respectively.

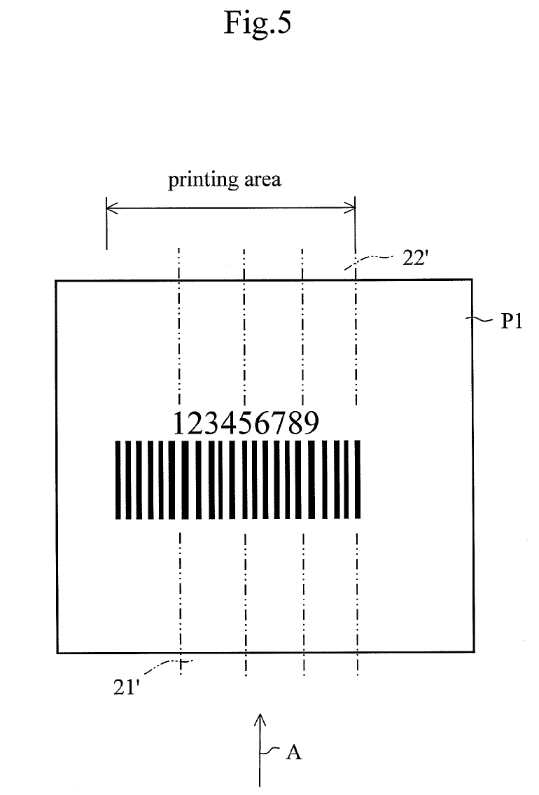

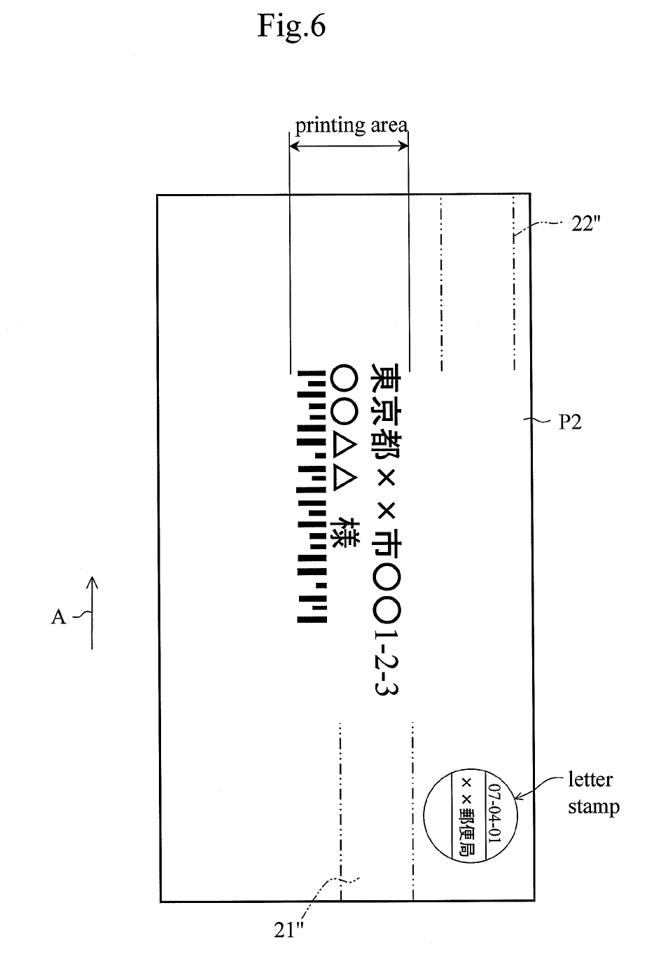

The images formed by the image-forming apparatus 10 are described with reference to FIG. 5 and FIG. 6.

FIG. 5 is a plan view of a label having a printed bar-code. FIG. 6 is a plan view of an envelope on which a letter stamp, an address, and a name are printed.

In printing of a bar-code extending perpendicularly to the sheet delivery direction (arrow-A direction) on a label P1, as illustrated in FIG. 5, the portion denoted by two-dot chain lines 21′ is brought into contact with the first delivery belt 21, and the portion denoted by two-dot chain lines 22′ is brought into contact with the second delivery belt 22 for the sheet delivery. The label P1 fed from the upstream side in the arrow-A direction is firstly delivered by the first delivery belt 21, and successively delivered by the second delivery belt 22. During the label delivery, the portion of the bar-code on the right side of the bar indicated by the numeral “7” in FIG. 5 is printed by the first recording head 31. Then on this label P1 on which a part of the bar-code has been printed, the rest portion at the left side of the numeral “7” in FIG. 5 is printed by the second recording head 32. Thus, even on a wide print region in the paper sheet width direction, the image-forming apparatus 10 forms an image over the entire width of the label P1 by employing the two recording heads 31,32 which are placed on the opposite sides.

In printing an address and a name on the center portion of the width direction and a stamp on the left end region of an envelop as illustrated in FIG. 6, the portion denoted by two-dot chain lines 21′ is brought into contact with the first delivery belt 21, and the portion denoted by two-dot chain lines 22′ is brought into contact with the second delivery belt 22 for feeding the envelope. The envelop P2 which has been delivered from the upstream side in the arrow-A direction is delivered by the first belt 21, and successively by the second delivery belt 22. During the delivery of the envelop, the letter stamp is printed as shown in FIG. 6 by the first recording head 31, and successively on this envelop P2 on which the stamp has been printed, the address and the name are printed by the second recording head 32. In such a manner, even on a narrow and long recording medium on which the printing area is wide in the paper sheet width direction, the image-forming apparatus 10 can print the image over the entire face of the envelope P2 by employing the two recording heads 31,32 placed in juxtaposition.

In the image-forming apparatus of the present invention, the recording medium is delivered by the first delivery means and successively by the second delivery means. The first recording head is movable only within a first one side of the first delivery means in the paper sheet width direction, and is capable of printing on any portion on the first one side of the recording medium. The second recording head is movable only within a second one side of the second delivery means in the paper sheet width direction, and is capable of printing on any portion on the second one side of the recording medium. That is, the first recording head and the second recording head are movable respectively within the opposite side region. Thereby an image can be formed over the entire width of the recording medium by the two recording heads. Therefore an image can be formed on any position of the recording medium by the two recording heads of one image-forming apparatus regardless of the paper sheet width (whether the sheet is wide or narrow).

1. An image-forming apparatus for forming an image on a predetermined position of a recording medium by delivering the recording medium by pressing a face of the recording medium, the apparatus comprising:
a first delivery means for delivering the recording medium by pressing a part of the face of the recording medium,
a first recording head movable only within a first one side of the first delivery means in the width direction of the recording medium perpendicular to the delivery direction,
a second delivery means placed in the downstream side of the first delivery means in the first one side in the width direction of the recording medium and delivers the recording medium by pressing a part of the face of the recording medium, and
a second recording head movable within a second one side of the second delivery means opposite to the first one side.

2. The image-forming apparatus according to claim 1, wherein the first delivery means and the second delivery means are respectively an endless type of delivery belt which delivers the recording medium by pressing the face of the recoding medium.

3. The image-forming apparatus according to claim 1, wherein a pair of guiding means extending in the width direction of the recording medium is provided for guiding the first recording head and the second recording head.

4. The image-forming means according to claim 3, wherein the pair of the guiding means is constituted of cylindrical shafts.

5. The image-forming means according to claim 1, wherein a spacer means is provided for regulating the gap between the first recording head and the recording medium and between the second recording head and the recording medium.

6. The image-forming means according to claim 2, wherein a spacer means is provided for regulating the gap between the first recording head and the recording medium and between the second recording head and the recording medium.

7. The image-forming means according to claim 3, wherein a spacer means is provided for regulating the gap between the first recording head and the recording medium and between the second recording head and the recording medium.

8. The image-forming means according to claim 4, wherein a spacer means is provided for regulating the gap between the first recording head and the recording medium and between the second recording head and the recording medium.

9. The image-forming apparatus according to claim 2, wherein a pair of guiding means extending in the width direction of the recording medium is provided for guiding the first recording head and the second recording head.

10. The image-forming means according to claim 9, wherein a spacer means is provided for regulating the gap between the first recording head and the recording medium and between the second recording head and the recording medium.

11. The image-forming means according to claim 9, wherein the pair of the guiding means is constituted of cylindrical shafts.

12. The image-forming means according to claim 11, wherein a spacer means is provided for regulating the gap between the first recording head and the recording medium and between the second recording head and the recording medium.
